(19) United States
(12) Patent Application Publication
(10) Pub. No.: US 2026/0179165 A1
(43) Pub. Date: Jun. 25, 2026

(54) DISASTER COUNTERMEASURE PLAN MAKING SYSTEM AND DISASTER COUNTERMEASURE PLAN MAKING METHOD

(71) Applicant: Hitachi, Ltd., Tokyo (JP)

(72) Inventors: Yu IKEMOTO, Tokyo (JP); Michiki NAKANO, Tokyo (JP); Yoshiki YUMBE, Tokyo (JP)

(73) Assignee: Hitachi, Ltd., Tokyo (JP)

(21) Appl. No.: 18/842,587

(22) PCT Filed: Sep. 7, 2022
(86) PCT No.: PCT/JP2022/033570

§ 371 Date: Aug. 29, 2024

(30) Foreign Application Priority Data
Mar. 25, 2022 (JP) 2022-049288

(51) Int. Cl. G06Q 50/26; G06Q 10/0631

(52) U.S. Cl. CPC G06Q 50/265; G06Q 10/06315

(57) ABSTRACT

A disaster countermeasure plan making system includes an arithmetic unit configured to execute arithmetic processing and a storage unit accessible by the arithmetic unit. The arithmetic unit includes a plan making unit that makes a countermeasure plan in preparation for a predetermined disaster. The plan making unit evaluates at least a benefit of the countermeasure based on a prediction value for each of a power outage time and unserved energy in an area for which a power outage is predicted due to the disaster, a prediction value for each of a power outage time and unserved energy in a case where a countermeasure is taken in the area, first information including a time that a power consumer affected by the power outage in the area needs to take an advance countermeasure, and second information regarding a loss associated with the disaster.

### CROSS-REFERENCE TO RELATED APPLICATION

The present application claims the priority of Japanese Patent Application No. 2022-49288, filed on Mar. 25, 2022, the entire contents of which are incorporated herein by reference.

### TECHNICAL FIELD

The present invention relates to a disaster countermeasure plan making system and a disaster countermeasure plan making method for supporting advance countermeasures for reducing a power outage at the time of occurrence of a disaster.

### BACKGROUND ART

In recent years, accompanying the climate change and the like, the occurrence of natural disasters such as flood and rainstorm has been increasing around the world. Japan has a territory with a higher frequency of natural disasters such as typhoon, heavy rain, and earthquake as compared with various other countries, and a disaster countermeasure is an important issue. In particular, in recent years, power outage damage caused by typhoon has been expanding, and in the power field, a reduction in power outage frequency, scale, and time with respect to an extreme increase in the risk of natural disasters is required. As a means for reducing the damage caused by typhoon, it is conceivable to formulate in advance a plan (contingency plan) for reducing the damage to the minimum based on weather forecast and prediction of a typhoon course. In the case of a contingency plan according to a power transmission and distribution operator, based on estimation of damage caused by a power outage, it is possible to reduce the power outage by temporarily changing the power plant (shifting the power generator) that supplies power to each area managed by the power transmission and distribution operator, and by replacing the power supply by distributed energy resources (DER) such as a power supply vehicle, a storage battery, and an electric vehicle.

For this purpose, it is important to develop a technique for quantitatively grasping the influence of power supply stop due to a power outage on society. Techniques disclosed in Patent Literatures 1 and 2 have been proposed as various related arts relating to a disaster countermeasure method in consideration of the influence of a power outage at the time of a disaster on the society.

Patent Literature 1 (JP2010-020434A) discloses a power outage evaluation device including: a unit configured to calculate the number of power outage accidents for each power outage occurrence cause in a locational condition, a power line drawing mode, and a power reception mode that are input by an input unit, by referring to data stored in a natural disaster data storage unit, a power line data storage unit, and a power outage accident cause data storage unit; a unit configured to obtain an influence range of a single power outage by referring to the data stored in the power line data storage unit; a unit configured to calculate the number of power outages per consumer for each power outage occurrence cause in the input locational condition, power line drawing mode, and power reception mode based on the calculated number of power outage accidents for each power outage occurrence cause and the obtained influence range; a unit configured to calculate the number of power outages per consumer for each power outage time based on the number of power outages per consumer for each power outage occurrence cause and the data stored in the power outage time data storage unit; and a unit configured to calculate an average power outage time from the number of power outages per consumer for each power outage time.

Patent Literature 2 (JP2007-221975A) discloses a power distribution system evaluation device including an input unit, a display unit, a processing unit, and a storage unit. The input unit inputs an accident section and a power outage time. A power outage section specifying unit of the processing unit specifies a power outage section based on the accident section from the input unit and distribution system data in the storage unit. An electric energy calculation unit specifies a consumer in the power outage section based on the power outage section specified by the power outage section specifying unit and power distribution facility data, and calculates supply failure electric energy based on power consumption of each consumer in consumer data and the power outage time input by the input unit. A loss rate calculation unit calculates the amount of loss of power rate for each consumer based on a power rate per unit power in the consumer data and the supply failure electric energy calculated by the electric energy calculation unit, and uses a total value of the amounts of loss as a loss rate. The display unit displays the loss rate calculated by the loss rate calculation unit.

### SUMMARY OF INVENTION

### Technical Problem

As described above, Patent Literature 1 discloses a method of estimating the amount of loss in factory production or the like of a consumer due to a power outage by assuming, for example, a fixed amount of loss per unit time due to stop of production facility of the consumer.

However, actually, the amount of loss per unit time due to the power outage is not fixed, and varies depending on the type of the consumer such as a general household and a business operator and a business size thereof. Even for the same consumer, the value of the amount of loss changes depending on a period in which the power outage occurs or a duration time of the power outage. For example, in the case of a business operator having a storage battery as a business continuity plan (BCP), the loss can be reduced in a certain period of time. But when the duration time of the power outage increases, the amount of loss per unit time from a time-point when the storage battery residual capacity is zero increases. In a case where there is no advance notice of a power outage, since it is not possible for the consumer to take an emergency measure against the power outage, the amount of loss per unit time may increase greatly as compared with a case where there is an advance notice.

Patent Literature 2 discloses a method of quantitatively estimating the influence of a power outage based on a consignment income decrease amount of a power transmission and distribution operator due to a power outage. Apart from the consignment income, losses such as a countermeasure cost, a penalty to the power outage in a consignment rate system (revenue cap system) scheduled to be introduced in Japan, or an incentive to avoid the power outage are not considered.

Accordingly, in the related art disclosed in Patent Literatures 1 and 2, the power outage loss including the countermeasure cost related to the contingency plan of the power transmission and distribution operator (use cost of the power generator shifting, the power supply vehicle, and the DER) and the advance countermeasure possible time of the consumer which changes with time is not considered. Therefore, it is not possible to accurately estimate the loss of the consumer or the power transmission and distribution operator, and as a result, there is a problem that the loss may increase since a sufficient countermeasure cannot be taken, or conversely, excessive countermeasures may be taken, leading to an increase in the countermeasure cost.

An object of the invention is to provide a disaster countermeasure plan making system and a disaster countermeasure planning method with which, for an area managed by a power transmission and distribution operator, based on a type of the consumer in each area and an advance countermeasure possible time of the consumer, a total benefit of a contingency plan based on a sales loss of the power transmission and distribution operator (consignment income decrease, power outage penalty, and the like), a countermeasure cost (power supply shift, distributed power supply operating cost, and the like), and a power outage loss of the consumer is evaluated, and a contingency plan improving the total benefit by performing optimization based on an evaluation value can be made.

### Solution to Problem

A representative example for solving the problems of the invention is as follows. That is, a disaster countermeasure plan making system includes an arithmetic unit configured to execute arithmetic processing and a storage unit accessible by the arithmetic unit. The arithmetic unit includes a plan making unit that makes a countermeasure plan in preparation for a predetermined disaster. The plan making unit evaluates at least a benefit of the countermeasure based on a prediction value for each of a power outage time and unserved energy in an area for which a power outage is predicted due to the disaster, a prediction value for each of a power outage time and unserved energy in a case where a countermeasure is taken in the area, first information including a time that a power consumer affected by the power outage in the area needs to take an advance countermeasure, and second information regarding a loss associated with the disaster.

### Advantageous Effects of Invention

According to an aspect of the invention, the cost effectiveness of the power transmission and distribution operator can be improved. Problems, configurations, and effects other than those described above will be clarified by the description of the following embodiments.

### BRIEF DESCRIPTION OF DRAWINGS

FIG. 1 is a screen image of presentation of typhoon course information to a power transmission and distribution operator.

FIG. 2 is a configuration diagram of a disaster countermeasure plan making system.

FIG. 3 is a software configuration of a disaster countermeasure plan making unit.

FIG. 4 is a software configuration of a consumer loss calculation unit.

FIG. 5 is a flowchart illustrating an overall processing procedure of a disaster countermeasure plan making unit.

FIG. 6 is a flowchart illustrating a processing procedure of countermeasure-not-taking cost benefit evaluation.

FIG. 7 is a flowchart illustrating a processing procedure of cost benefit evaluation of an initial contingency plan.

FIG. 8 is a flowchart illustrating a processing procedure of provisional contingency plan assumption.

FIG. 9 is a flowchart illustrating a processing procedure of cost benefit evaluation of a provisional contingency plan.

FIG. 10 is a flowchart illustrating a processing procedure of consumer loss estimation.

FIG. 11 illustrates table example of in-area renewable energy power supply introduction amount.

FIG. 12 illustrates a data table example of a weather prediction value.

FIG. 13 illustrates a data table example of a power supply list.

FIG. 14 illustrates a data table example of power supply vehicle information.

FIG. 15 illustrates a data table example of area-specific storage battery information.

FIG. 16 illustrates a data table example of an area demand prediction value.

FIG. 17 illustrates a data table example of a power supply-specific operating cost unit price.

FIG. 18 illustrates a data table example of a power supply shift cost unit price.

FIG. 19 illustrates a data table example of a power supply vehicle operation unit price.

FIG. 20 illustrates a data table example of an initial contingency plan evaluation result.

FIG. 21 illustrates a data table example of a contingency plan optimization result.

FIG. 22 illustrates a data table example of a power outage time and unserved energy estimation result.

FIG. 23 illustrates a data table example of a consumer-specific required advance countermeasure time.

FIG. 24 illustrates a data table example of a case-specific power outage cost estimated unit price.

FIG. 25 illustrates a data table example of a consumer loss calculation result.

FIG. 26 illustrates an image of the case-specific power outage cost estimated unit price.

FIG. 27 illustrates a screen image for a power transmission and distribution operator.

FIG. 28 illustrates a calculation image of a loss influence degree.

FIG. 29 illustrates a comparison image of a consumer loss and a countermeasure cost of a power transmission and distribution operator.

### DESCRIPTION OF EMBODIMENTS

Hereinafter, specific embodiments of the invention will be described with reference to the drawings.

In a system disclosed in the embodiment, when arrival of a typhoon is predicted by weather forecast, an economically reasonable contingency plan is made from the viewpoint of the magnitude of a predicted power outage damage amount due to a system failure or generator detachment predicted based on weather forecast data, and a countermeasure cost of a plurality of means such as a power generator shift, a temporary supply by a power supply vehicle, and a temporary supply using DER such as a storage battery.

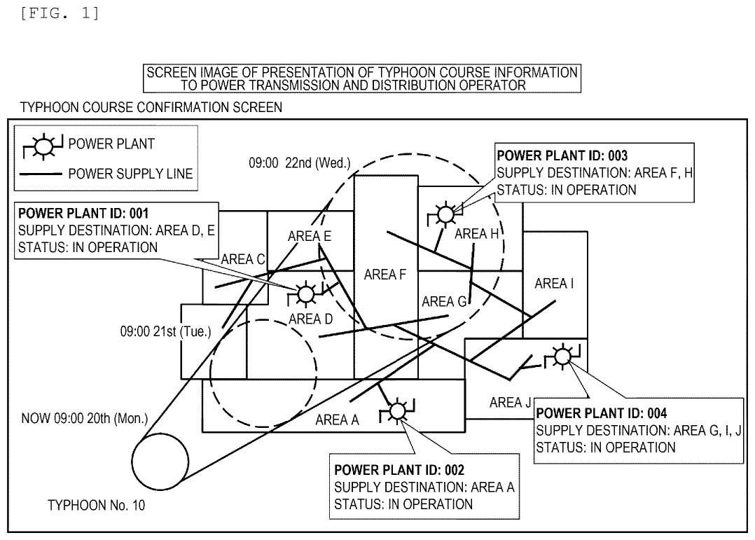

FIG. 1 may be an example of a screen image of typhoon course information to be confirmed by a power transmission and distribution operator at the time of typhoon arrival prediction in the embodiment. The power transmission and distribution operator can confirm an area where a typhoon is predicted to reach in assigned areas (in the present specification, unless otherwise specified, the term “area” refers to an area the power transmission and distribution operator is responsible for) and a power plant likely to be affected, and can make a contingency plan based on the information. Power may be supplied from each power plant to each area via a power supply line in FIG. 1.

### (1) CONFIGURATION OF DISASTER COUNTERMEASURE PLAN MAKING SYSTEM

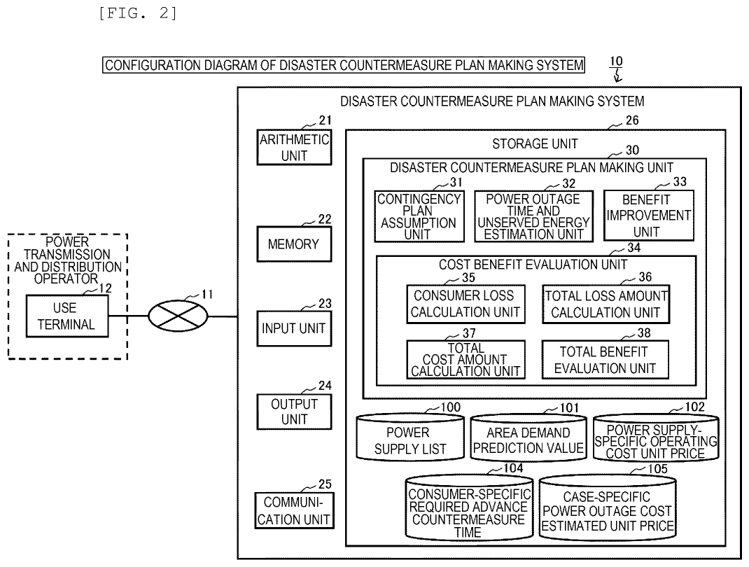

FIG. 2 is a diagram illustrating a configuration example of a disaster countermeasure plan making system 10 according to the embodiment. The disaster countermeasure plan making system 10 may include a storage unit 26 accessible by an arithmetic unit 21 described later, which is implemented by an appropriate non-volatile storage element such as a hard disk drive. Further, a memory 22 implemented by a volatile storage element such as a RAM and the arithmetic unit 21 may be provided. The arithmetic unit 21 reads a program held in the storage unit 26 into the memory 22 and executes the program to perform overall control of the system itself, and performs various determinations, arithmetic processing and control processing of a central processing unit (CPU), and the like. Further, an input unit 23 such as a keyboard or a mouse that accepts an input of a user, an output unit 24 such as a display that outputs a processing result, and a communication unit 25 such as a network interface that is connected to a communication network 11 and performs communication processing with another device such as an external use terminal 12 may be provided.

Functional units of the storage unit 26 are implemented by the arithmetic unit 21 executing a program, and include a disaster countermeasure plan making unit 30 that is a plan making unit including a contingency plan assumption unit 31, a power outage time and unserved energy estimation unit 32, a benefit improvement unit 33, and a cost benefit evaluation unit 34. The plan making unit makes a plan for a countermeasure in preparation for a predetermined disaster. The disaster countermeasure plan making unit 30 may be a functional unit that implements a disaster countermeasure plan making function described later. With regard to the name of the contingency plan assumption unit, the contingency plan is obtained by simplifying the contingency plan. In the following description, the contingency plan is obtained by simplifying the contingency plan. Accordingly, the meaning is the same even if a contingency plan is replaced with a contingency plan.

The cost benefit evaluation unit 34 may include a consumer loss calculation unit 35, a total loss calculation unit 36, a total cost calculation unit 37, and a total benefit evaluation unit 38.

The storage unit 26 can store, as a database, information such as a power supply list 100, an area demand prediction value 101, a power supply-specific operating cost unit price 102, a consumer-specific required advance countermeasure time 104, and a case-specific power outage cost estimated unit price 105.

The disaster countermeasure plan making system 10 may be a local server installed at a specific location, or may be provided in a form of software-as-a-service (Saas) or the like as a cloud server.

The communication network 11 is connected to the use terminal 12 of a power transmission and distribution operator or the like. The use terminal 12 can receive inputs of power generator information, power supply vehicle information, and the like of a target area from the power transmission and distribution operator.

### (2) DISASTER COUNTERMEASURE PLAN MAKING FUNCTION

Next, the disaster countermeasure plan making function of the disaster countermeasure plan making system 10 will be described. The disaster countermeasure plan making function may include an evaluation unit that evaluates at least benefits of a countermeasure based on the following elements: a prediction value of each of a power outage time and unserved energy of areas including an area in which a power outage is predicted due to a disaster at the time of occurrence of the disaster; a prediction value of each of a power outage time and unserved energy in a case where an assumed contingency plan is taken, that is, a prediction value of each of a power outage time and unserved energy in a case where the countermeasure is taken in the area; information that may include types of consumers in each area and an advance countermeasure possible time of the consumer, that is, first information including a time that a power consumer to be affected by a power outage in the area requires to take an advance countermeasure; and information including a sales loss of the power transmission and distribution operator, a countermeasure cost, and a power outage loss of the consumer, that is, information regarding a loss associated with the disaster.

With this configuration, based on the information regarding the consumer in addition to the information regarding the loss associated with the disaster, the disaster countermeasure plan can be made.

Further, the above-described evaluation unit may evaluate total benefits of the assumed contingency plan, and may have a function of specifying a contingency plan whose benefit is improved based on the evaluation result. The benefit refers to an advantage that takes a disadvantage into account as well.

With this configuration, in consideration of the information regarding the consumer in addition to the information regarding the loss associated with the disaster, a better disaster countermeasure plan can be made.

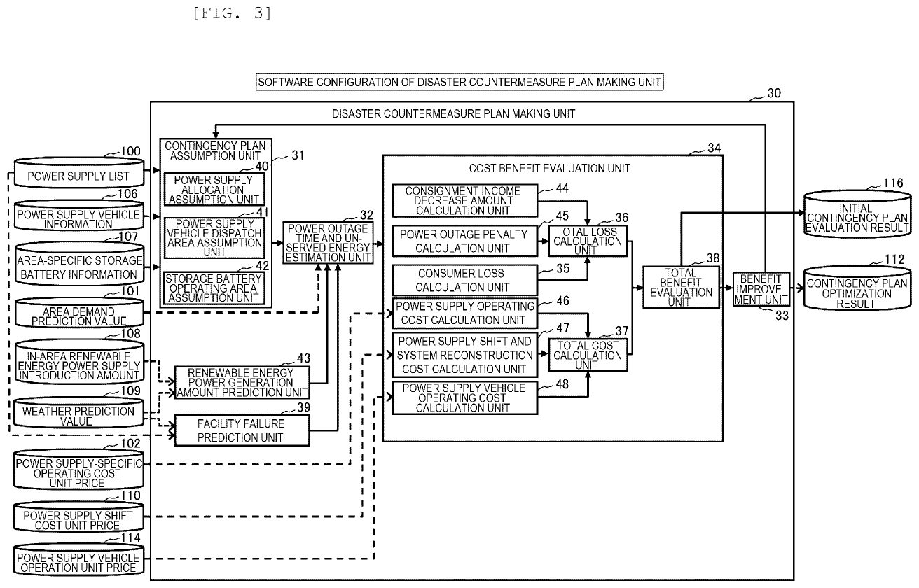

FIG. 3 is a software configuration diagram of the disaster countermeasure plan making system 10 according to the disaster countermeasure plan making function. In order to implement such a disaster countermeasure plan making function, the storage unit 26 of the disaster countermeasure plan making system 10 may hold, as a program, the disaster countermeasure plan making unit 30 including a facility failure prediction unit 39, a renewable energy power generation amount prediction unit 43, the contingency plan assumption unit 31, the power outage time and unserved energy estimation unit 32, the cost benefit evaluation unit 34, and the benefit improvement unit 33. In FIG. 3, regarding lines connecting components, solid line may denote a flow of processing, and a broken line may denote a flow of data. In the drawings including FIG. 3, not all necessary lines connecting the components are illustrated, and some may be omitted. The flow of processing between the components and the flow of data are appropriately achieved even if lines are not displayed in the drawings.

Hereinafter, each function will be described in detail.

The contingency plan assumption unit 31 is a processing unit that assumes a contingency plan, and may include a power supply allocation assumption unit 40, a power supply vehicle dispatch area assumption unit 41, and a storage battery operating area assumption unit 42.

The power supply allocation assumption unit 40 may be a processing unit that assumes, using the power supply list 100, allocation of areas where the corresponding power plant performs power supply.

The power supply vehicle dispatch area assumption unit 41 may be a processing unit that assumes, using power supply vehicle information 106, allocation of areas where the corresponding power supply vehicle performs power supply.

The storage battery operating area assumption unit 42 may be a processing unit that assumes, using area-specific storage battery information 107, allocation of areas where the corresponding storage battery performs power supply.

The renewable energy power generation amount prediction unit 43 can perform processing of predicting a renewable energy power generation amount of each area using an in-area renewable energy power supply introduction amount 108 and a weather prediction value 109.

The facility failure prediction unit 39 can perform processing of predicting a failure of a power plant, a power supply line or the like of each area using the power supply list 100 and the weather prediction value 109.

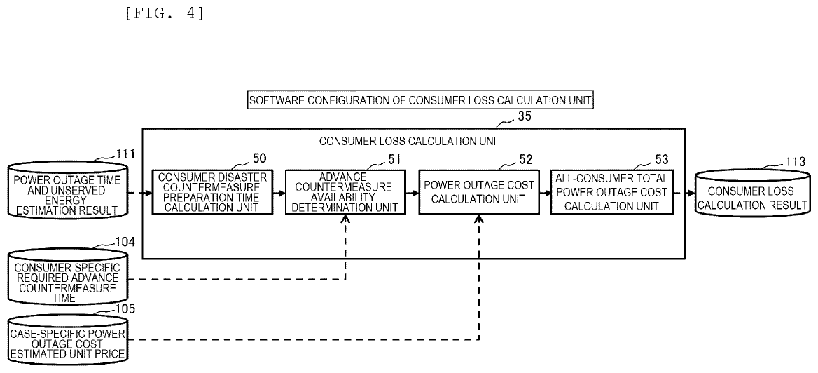

The power outage time and unserved energy estimation unit 32 is a processing unit that performs processing of estimating a power outage time and unserved energy of each area by using the assumed contingency plan, the area demand prediction value 101, a renewable energy power generation amount prediction value that is a value of the renewable energy power generation amount of each area predicted by the renewable energy power generation amount prediction unit 43, and a facility failure prediction result that is a result predicted by the facility failure prediction unit 39, and the processing result can be stored in a power outage time and unserved energy estimation result 111 illustrated in FIG. 4.

The cost benefit evaluation unit 34 may include a consignment income decrease amount calculation unit 44, a power outage penalty calculation unit 45, the consumer loss calculation unit 35, the total loss calculation unit 36, a power supply operating cost calculation unit 46, a power supply shift and system reconstruction cost calculation unit 47, a power supply vehicle operating cost calculation unit 48, the total cost calculation unit 37, and the total benefit evaluation unit 38.

The consignment income decrease amount calculation unit 44 can perform processing of calculating a consignment income decrease amount based on an estimation result of the unserved energy of each area.

The power outage penalty calculation unit 45 can perform processing of calculating a loss due to a penalty of the power outage based on the estimation result of the unserved energy of each area.

The consumer loss calculation unit 35 may be a processing unit that performs processing of calculating damages to the consumer based on the estimation result of the unserved energy of each area.

The power supply operating cost calculation unit 46 may be a processing unit that calculates an operating cost of each power supply using power supply allocation of the assumed contingency plan, the power supply list 100, the area demand prediction value 101, and the power supply-specific operating cost unit price 102. In FIG. 3, lines indicating data transmission from the power supply list 100 and the area demand prediction value 101 to the power supply operating cost calculation unit 46 are omitted.

The power supply shift and system reconstruction cost calculation unit 47 may be a processing unit that calculates a cost for power supply shift using the power supply allocation of the assumed contingency plan and a power supply shift cost unit price 110.

The power supply vehicle operating cost calculation unit 48 may be a processing unit that calculates a cost for power supply vehicle dispatch and operation using power supply vehicle dispatch allocation of the assumed contingency plan and a power supply vehicle operation unit price 114.

The total loss calculation unit 36 may be a processing unit that calculates a total loss based on a consignment income decrease amount calculation result that is a result of the processing of the consignment income decrease amount calculation unit 44, a power outage penalty calculation result, and a consumer loss calculation result.

The total cost calculation unit 37 may be a processing unit that calculates a total cost based on a power supply operating cost calculation result that is a result of the calculation of the power supply operating cost by the power supply operating cost calculation unit 46, a power supply shift cost calculation result that is a result of the calculation of the power supply shift cost by the power supply shift and system reconstruction cost calculation unit 47, and a power supply vehicle operating cost calculation result that is a result of the calculation of the power supply vehicle operating cost by the power supply vehicle operating cost calculation unit 48.

The total benefit evaluation unit 38 is a processing unit that evaluates total benefits based on the total loss calculated by the total loss calculation unit 36 and the total cost calculated by the total cost calculation unit 37. When evaluating an initial contingency plan, an evaluation result thereof may be stored in an initial contingency plan evaluation result 116. That is, the second information regarding the loss associated with the disaster may be information including the sales loss of the power transmission and distribution operator, the cost required for the countermeasure, and the power outage loss of the power consumer.

With this configuration, it is possible to make a disaster countermeasure plan in consideration of the power outage loss of the power consumer in addition to the sales loss of the power transmission and distribution operator and the cost required for the countermeasure.

Further, the sales loss of the power transmission and distribution operator may include the consignment income decrease amount and/or a power outage penalty amount. The cost required for the countermeasure may include a cost required for the power supply operation and/or a distributed power supply operating cost.

With this configuration, it is possible to make a disaster countermeasure plan in which a loss related to a power outage is taken into consideration more properly.

The benefit improvement unit 33 is a processing unit that performs processing of searching for a new contingency plan whose total benefits are improved, based on a total benefit evaluation result evaluated by the total benefit evaluation unit 38, and the processing result may be stored in a contingency plan optimization result 112.

FIG. 4 is a software configuration diagram of the consumer loss calculation unit 35. In order to calculate the consumer loss, a consumer disaster countermeasure preparation time calculation unit 50, an advance countermeasure availability determination unit 51, a power outage cost calculation unit 52, and an all-consumer total power outage cost calculation unit 53 may be held.

The consumer disaster countermeasure preparation time calculation unit 50 can calculate a disaster countermeasure preparation time of a consumer using the power outage time and unserved energy estimation result 111.

The advance countermeasure availability determination unit 51 can determine advance countermeasure availability of each consumer using the disaster countermeasure preparation time of the consumer calculated by the consumer disaster countermeasure preparation time calculation unit 50 and the consumer-specific required advance countermeasure time 104.

The power outage cost calculation unit 52 calculates a loss of the consumer incurred due to a power outage using a determination result of the advance countermeasure availability of the consumer by the advance countermeasure availability determination unit 51, and data of the case-specific power outage cost estimated unit price 105.

The all-consumer total power outage cost calculation unit 53 calculates a total power outage cost of all consumers by summing up losses of all consumers incurred due to the power outage calculated by the power outage cost calculation unit 52, and the processing result may be stored in a consumer loss calculation result 113.

### (3) VARIOUS TYPES OF PROCESSING RELATED TO DISASTER COUNTERMEASURE PLAN MAKING FUNCTION

Next, processing contents of various types of processing performed by the disaster countermeasure plan making system 10 in relation to the disaster countermeasure plan making function according to the embodiment will be described. In the following description, although a processing subject of the various types of processing is described to be a program or a module, it goes without saying that an arithmetic unit may execute the processing based on the program or the module.

An overall processing procedure of the disaster countermeasure plan making is shown in section 3-1 “various types of processing of disaster countermeasure plan making”. A detailed processing procedure of the consumer loss calculation is shown in section 3-2 “various types of processing of consumer loss calculation”.

### (3-1) Various Types of Processing of Disaster Countermeasure Plan Making

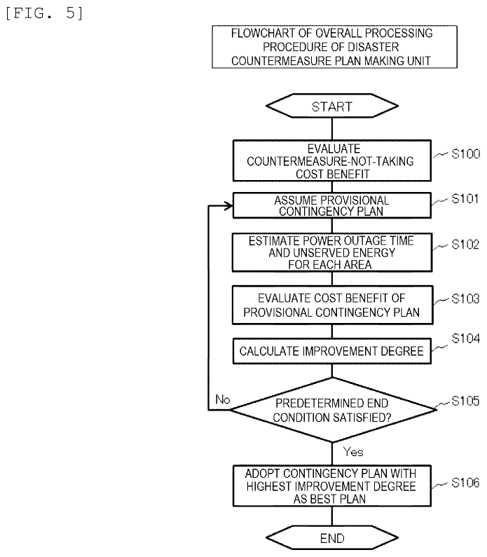

FIG. 5 is a flowchart illustrating the overall processing procedure of the disaster countermeasure plan making unit of the disaster countermeasure plan making system 10. The disaster countermeasure plan making unit 30 of the disaster countermeasure plan making system 10 may sequentially execute countermeasure-not-taking cost benefit evaluation (step S100), provisional contingency plan assumption (step S101), power outage time and unserved energy estimation for each area (step S102), cost benefit evaluation of the provisional contingency plan (step S103), improvement degree calculation (step S104), predetermined end condition check (step S105), and adoption of a contingency plan with the highest improvement degree as a best plan (step S106).

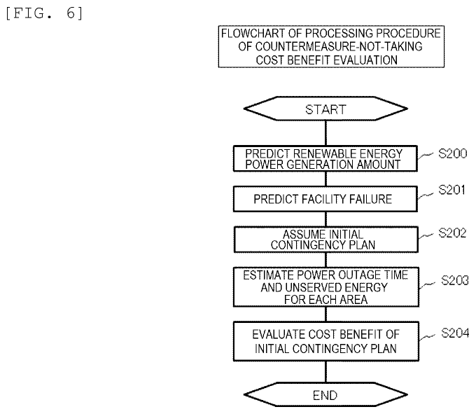

FIG. 6 is a flowchart illustrating a processing procedure of the countermeasure-not-taking cost benefit evaluation (step S100).

When the countermeasure-not-taking cost benefit evaluation processing is started, first, the renewable energy power generation amount prediction unit 43 can perform processing of predicting an area-specific photovoltaic power generation amount using the in-area renewable energy power supply introduction amount 108 and the weather prediction value 109 (step S200).

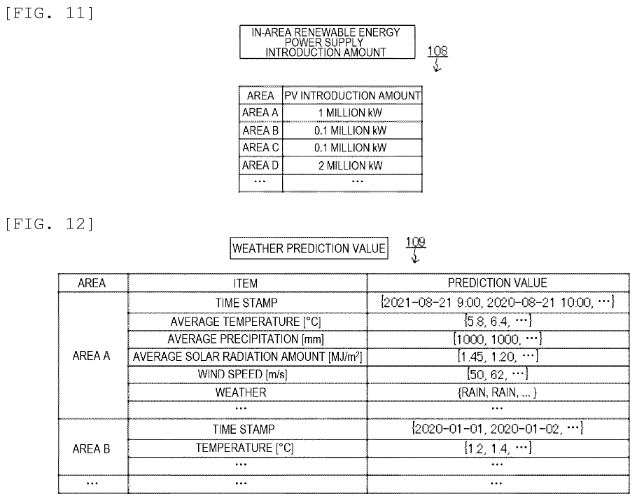

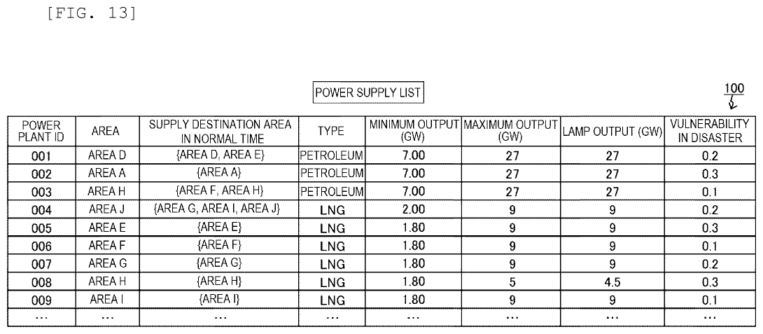

For example, an area displayed as an “area” and a “PV introduction amount” which is a photovoltaic power generation introduction amount for each area may be set in the in-area renewable energy power supply introduction amount 108 in a format shown in FIG. 11. The weather prediction value 109 stores, for example, weather prediction values of an average temperature, average precipitation, an average solar radiation amount, a wind speed, and weather at each time-point in each area in the format shown in FIG. 12. In the weather prediction value 109 in FIG. 12, timings at which a prediction is performed are listed in time series in a “prediction value” corresponding to a “time stamp”. In the “prediction value” column corresponding to a weather element such as the “average temperature” listed in an “item” column, prediction values of respective weather elements are listed correspondingly to the timings at which a prediction is performed. The “rain” corresponding to “weather” is not an apparent numerical value, but may be treated as a numerical value in the processing and is thus called a prediction value. In the prediction of the area-specific photovoltaic power generation amount, for example, a solar radiation amount prediction value and the photovoltaic power generation introduction amount in the area are multiplied with a predetermined coefficient weight, whereby a renewable energy power generation amount prediction value for each time period can be calculated. Here, the time period is a time range between a certain time point and a certain time point, and the renewable energy power generation amount prediction value is calculated as a total value of power generation amounts in the time period.

Next, the facility failure prediction unit 39 can perform processing of predicting a failure of a power plant, a power supply line or the like of each area using the power supply list 100 and the weather prediction value 109 (step S201).

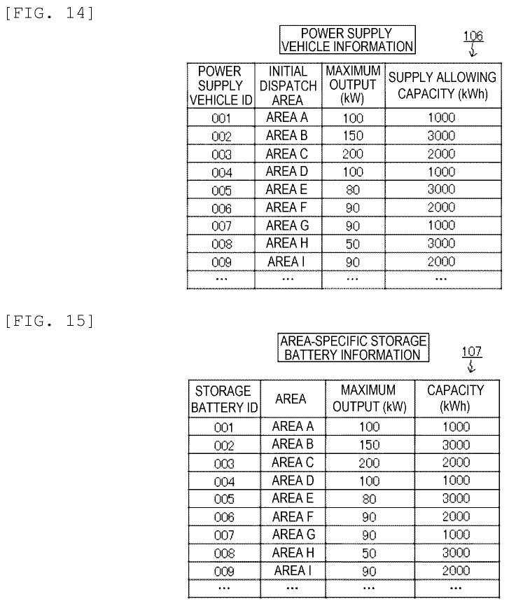

For example, in the format shown in FIG. 13, the power supply list 100 may store a “power plant ID” indicating a code for specifying a power plant, an “area” for each power plant that is an area where the power plant exists, a “supply destination area in normal time” that is an area to which a power plant supplies power in a normal time when no disaster or the like occurs, a “type” indicating an energy source used for power generation, a “maximum output” that is a maximum output of the power plant, and a “vulnerability in disaster” (vulnerability of the power plant in a disaster). In the facility failure prediction, a failure probability at each time point for each facility can be calculated using the following formula (1) based on the area of each power plant in the power supply list 100, the vulnerability in disaster, and the wind speed in each time period for each area in the weather prediction value 109. When the failure probability is equal to or larger than a threshold, a “failure” is determined, and when the failure probability is smaller than the threshold, “no failure” is determined. In addition to the weather elements shown in FIG. 12, various elements such as precipitation and snowfall may be adopted as weather elements listed as items in the weather prediction value 109. A symbol t may be used in the scope of the present formula.

In the power supply list 100 shown in FIG. 13, items such as the power plant ID are shown, and the items are listed as an example in the drawing. The various tables of data that are given for the description of the invention including the power supply list 100 are not limited to include the illustrated items, and may include various necessary items.

$$\begin{matrix}[ Formula 1 ] & \\ Failure probability at time - point t of power plant g = wind speed at time - point t in area of power plant g \times vulnerability in disaster of power plant g & ( 1 )\end{matrix}$$

Next, the contingency plan assumption unit 31 can assume an initial contingency plan by each of the power supply allocation assumption unit 40, the power supply vehicle dispatch area assumption unit 41, and the storage battery operating area assumption unit 42 assuming asset allocation in each area (step S202).

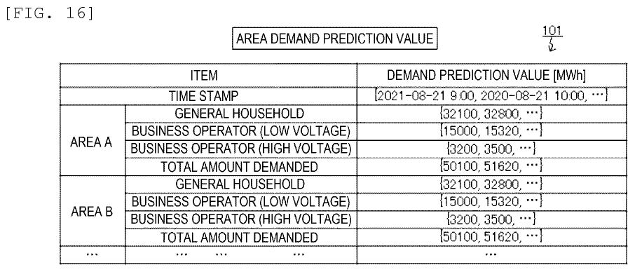

In the assumption of the initial contingency plan, first, the power supply allocation assumption unit 40 assumes the allocation of an initial area indicating an area where the corresponding power plant performs power supply at an initial stage. Specifically, the supply destination area in normal time in the power supply list 100 may be allocated as a supply destination of each power plant. Next, the power supply vehicle dispatch area assumption unit 41 assumes, based on the power supply vehicle information 106, the allocation of an initial area where the corresponding power supply vehicle performs power supply. FIG. 14 is an example of the power supply vehicle information 106 in which information is stored, such as a “power supply vehicle ID” indicating a code for specifying a power supply vehicle, an “initial dispatch area” for each power supply vehicle indicating an area where the power supply vehicle is dispatched at an initial stage, a “maximum output” indicating a maximum output of the power supply vehicle, and a “supply allowing capacity” that is a capacity of electric power that can be supplied by the power supply vehicle. In the assumption of the initial power supply vehicle dispatch area, for example, the determination may be made by referring to information on the initial dispatch area in the power supply vehicle information 106. Next, the storage battery operating area assumption unit 42 assumes operation and non-operation of each storage battery based on the area-specific storage battery information 107. FIG. 15 is an example of the area-specific storage battery information 107 in which information is stored, such as a “storage battery ID” indicating a code for specifying a storage battery, an “area” for each storage battery that is an area where the storage battery is provided, a “maximum output” that is a maximum output of the storage battery, and a “capacity” that is a capacity of the storage battery. In the assumption of the initial storage battery operation and non-operation, for example, all the storage batteries listed in the area-specific storage battery information 107 may be assumed to operate. With the above processing, as a contingency plan, it is possible to assume a power plant, a power supply vehicle, and a storage battery to be allocated to each area.

Next, the power outage time and unserved energy estimation unit 32 can perform processing of estimating presence or absence of a power outage and unserved energy in each area for each future time period in which a set power supply plan is to be carried out, by using the assumed contingency plan, the area demand prediction value 101, the renewable energy power generation amount prediction value, and the facility failure prediction result (step S203).

Specifically, an electric power supply amount of each area is calculated based on the assumed contingency plan, the renewable energy power generation amount prediction value, and the facility failure prediction result for the area, and the presence or absence of a power outage and the unserved energy for each time period can be estimated by comparing the calculated electric power supply amount with the area demand prediction value.

For example, operation availability of an allocated power plant is determined based on information on the power plant allocated to the area in the assumed contingency plan and the facility failure prediction result, and if the power plant can operate, “maximum output in the power supply list 100 in FIG. 13×time” can be calculated as the electric energy that the power plant can supply to the area in the time period. For example, when maximum power 27 (GW) is supplied in one hour, the electric power supply amount in the time period is 27 (GWh).

Further, based on information on the allocated power supply vehicle in the assumed contingency plan, “maximum output in the power supply vehicle information 106 in FIG. 14×time” can be calculated as the electric energy that the power supply vehicle can supply in the time period. At this time, supply availability may be determined based on how long the time period, in which set power supply is to be performed, occupies an elapsed time from a power supply start time. For example, when an elapsed time from the power supply start time is T, a total electric power supply amount up to the time period is calculated using “maximum output of the power supply vehicle×T”, and the value is compared with the supply allowing capacity in the power supply vehicle information 106. When the “total electric power supply amount up to the time period≥the supply allowing capacity”, it can be determined that electric power supply is impossible, and when “the total electric power supply amount<the supply allowing capacity”, it can be determined that the electric power supply is possible. The symbol T is used in the scope of the present formula.

Further, based on information on the allocated storage battery in the assumed contingency plan, “maximum output in the area-specific power storage battery information 107 in FIG. 15×time” are calculated as the electric energy that the storage battery can supply in the time period. At this time, supply availability may be determined based on how long the time period, in which set power supply is to be performed, occupies an elapsed time from a power supply start time. For example, when an elapsed time from the power supply start time is T, a total electric power supply amount up to the time period is calculated using “maximum output T of the storage battery×T”, and the value is compared with a capacity in the area-specific storage battery information 107. When the “total electric power supply amount up to the time period≥the capacity”, it can be determined that the electric power supply is impossible, and when the “total electric power supply amount up to the time period<the capacity”, it can be determined that the electric power supply is possible. The symbol T is used in the scope of the present formula.

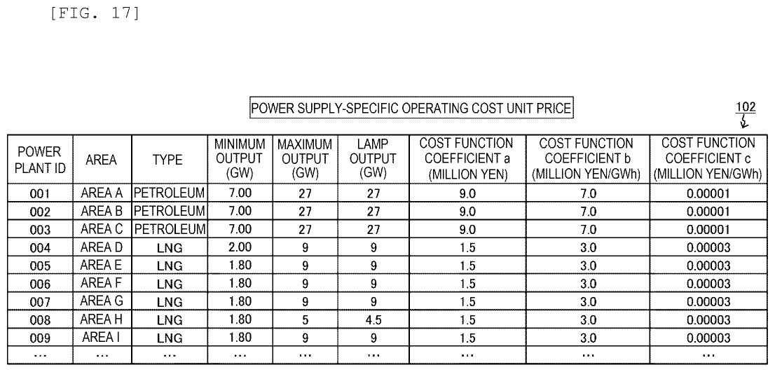

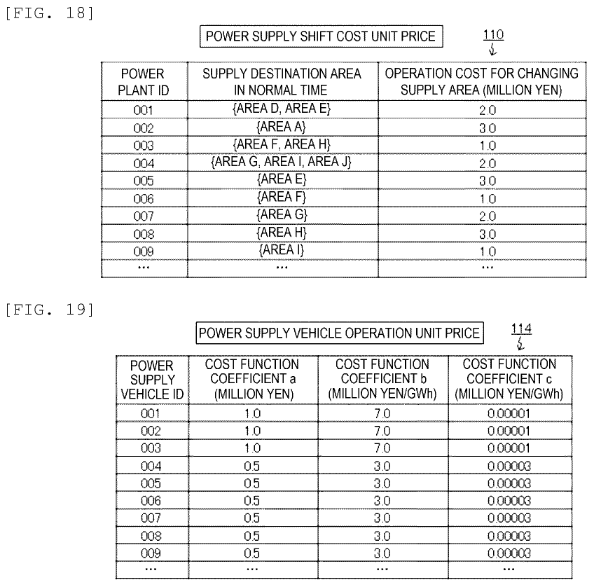

The electric power supply amount in each time period of the area can be calculated by adding up a total value of the electric power supply amounts of the power generator, the power supply vehicle, and the storage battery in each time period calculated in this manner and the renewable energy power generation amount prediction value in each time period. FIG. 16 is an example of the area demand prediction value 101 in which a demand prediction value for each consumer type (general household, business operator (high voltage), business operator (low voltage)) and a total amount demanded may be stored for each time period of each area. The electric power supply amount in each time period of the area is compared with the total amount demanded of the area in the area demand prediction value 101. When “the electric power supply amount≥the total amount demanded”, it may be determined that a power outage is absent, and when “the electric power supply amount<the total amount demanded”, it may be determined that a power outage is present. When a power outage is present, the total amount demanded can be estimated as the unserved energy in the time period. The unserved energy for each consumer type can be estimated by referring to the demand prediction value for each consumer type (general household, business operator (high voltage), business operator (low voltage)) in the area demand prediction value 101. The estimation result of the presence or absence of a power outage and the unserved energy of each area estimated in this way may be stored in the power outage time and unserved energy estimation result 111 in the format illustrated in FIG. 22.

Next, the cost benefit evaluation unit 34 can evaluate the cost and benefit to be generated, based on the assumed initial contingency plan and the power outage time and unserved energy estimation result 111 (step S204).

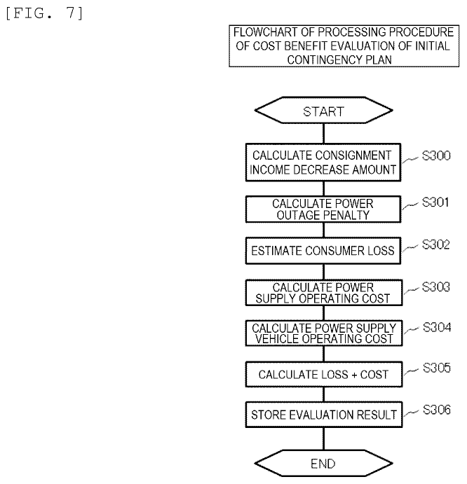

FIG. 7 is a flowchart illustrating details of a processing procedure of the cost benefit evaluation of the initial contingency plan (step S204).

When the cost benefit evaluation of the initial contingency plan is started, first, the consignment income decrease amount calculation unit 44 can perform processing of calculating the consignment income decrease amount based on the estimation result of the power outage time and unserved energy of each area (step S300). Specifically, a consignment rate unit price (yen/kWh) for each consumer type (general household, business operator (high voltage), business operator (low voltage)) may be set first. Next, as shown in formula (2), by taking the product of unserved energy for each consumer type in the power outage time and unserved energy estimation result 111, it is possible to calculate the consignment income decrease amount of each consumer type. The symbol t is used in the scope of the present formula.

$$\begin{matrix}[ Formula 2 ] & \\ {incomeLoss\_trans}_{a} = {\sum }_{c} {\sum }_{t} P L o s {s}_{a , c , t} \times u n i t P r i c {e}_{c} & ( 2 )\end{matrix}$$

Here, incomeLoss_transₐ is a consignment income decrease amount of an area a, PLOSS_{a,c,t} is total unserved energy (MWh) in a time period t of a consumer type c of the area a, and unitPrice_{c} is an average consignment rate unit price (yen/kWh) of the consumer type c.

As an example, the consignment income decrease amount can be calculated by the following formula. The symbol t is used in the present formula.

$$\begin{matrix}[ Formula 3 ] & \\ Consignment income decrease amount of general household = unserved energy in time period ( general household ) \times consignment rate unit price of general household ( yen / kWh ) & ( 3 )\end{matrix}$$

$$\begin{matrix}[ Formula 4 ] & \\ Consignment income decrease amount of business operator ( low voltage ) = unserved energy ( low voltage ) in time period \times consignment rate unit price ( yen / kWh ) of business operator ( low voltage ) & ( 4 )\end{matrix}$$

$$\begin{matrix}[ Formula 5 ] & \\ Consignment income decrease amount of business operator ( high voltage ) = unserved energy ( high voltage ) in time period \times consignment rate unit price ( yen / kWh ) of business operator ( high voltage ) & ( 5 )\end{matrix}$$

By adding up the consignment income decrease amounts of the respective consumer types, it is possible to calculate a consignment income decrease amount of all consumers.

Next, the power outage penalty calculation unit 45 can perform processing of calculating a loss due to a penalty of the power outage based on the estimation result of the unserved energy of each area (step S301). Specifically, first, values of a penalty unit price (yen/kWh) and allowable unserved energy (MWh) are set. The values may be any value of 0 or more. Next, as shown in formula (6), a power outage penalty can be calculated by multiplying a deviation amount from allowable unserved energy of the total unserved energy in all target time periods by the penalty unit price.

$$\begin{matrix}[ Formula 6 ] & \\ {penalty}_{a} = ( {\sum }_{c} {\sum }_{t} {P Loss}_{a , c , t} - Loss\_allowable ) \times unitPenelty & ( 6 )\end{matrix}$$

Here, penaltyₐ is a power outage penalty of the area a, Loss_allowable is allowable unserved energy (MWh) in the revenue cap, and unitPenalty is a penalty unit price (yen/MWh).

Next, the consumer loss calculation unit 35 can perform processing of calculating damages to the consumer based on the estimation result of the unserved energy of each area (step S302). Details of the consumer loss calculation processing will be described later in section 3-2 “various types of processing of consumer loss calculation”.

Next, the power supply operating cost calculation unit 46 can calculate an operating cost of each power supply, by using the power supply allocation of the contingency plan assumed by the power allocation assumption unit 40, the power supply list 100, and the area demand prediction value 101 (step S303). Specifically, first, it is possible to extract a power plant allocated to an area and determined in step S201. When one power generator is allocated to one area, a total amount demanded indicated by the area demand prediction value of the area can be set to a power generation amount of the power plant in all time periods. When a plurality of power generators are allocated to one area, the power generation amount of each power plant can be calculated by proportionally dividing the total amount demanded by a ratio of maximum outputs of the allocated power plants with reference to the power supply list 100. Next, coefficients a_{g}, b_{g}, and c_{g} of a cost function of the allocated power plant may be extracted with reference to the power supply list 100. The cost function is a function for calculating a cost of power generation according to the power generation amount of the power generator and the characteristics of the power generator. By using the coefficients (a_{g}, b_{g}, c_{g}) of the power generator cost function, the cost required for the operation in each time period can be calculated by the following formula.

$$\begin{matrix}[ Formula 7 ] & \\ {cost\_gene}_{g} = {a}_{g} + {b}_{g} \times {P}_{g} + {c}_{g} \times {P}_{g}^{2} & ( 7 )\end{matrix}$$

Here, cost_gene_{g} is an operating cost (yen) of a power supply g, and P_{g} is a power generation amount of a power generator g.

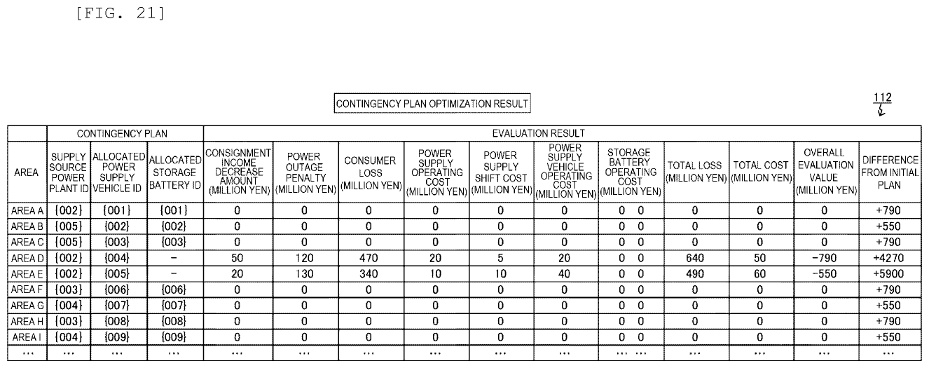

Next, the power supply vehicle operating cost calculation unit 48 can calculate a cost for power supply vehicle dispatch and operation by using the allocation of the power supply vehicle dispatch area in the contingency plan assumed by the power supply vehicle dispatch area assumption unit 41 and the power supply vehicle operation unit price 114 (step S304). Specifically, first, a power supply vehicle allocated to an area may be extracted. Then, coefficient aᵥₑₕ, bᵥₑₕ, and Cᵥₑₕ of a cost function of the allocated power supply vehicle may be extracted with reference to the power supply vehicle operation unit price 114 in FIG. 19. By using the coefficients (aᵥₑₕ, bᵥₑₕ, Cᵥₑₕ) of the cost function, the cost required for the operation in each time period can be calculated by the following formula.

$$\begin{matrix}[ Formula 8 ] & \\ cost\_p {\_vehicle}_{v} = {a}_{V e h} + {b}_{V e h} \times {P}_{V e h , v} + {c}_{V e h} \times {P}_{V e h , v}^{2} & ( 8 )\end{matrix}$$

Here, cost_p_vehicleᵥ is a cost of a power supply vehicle v, and P_{veh,v} is a power generation amount of the power supply vehicle V.

Next, the total loss calculation unit 36 can calculate a total loss by the following formula based on a consignment income decrease amount calculation result, a power outage penalty calculation result which is a calculation result of the power outage penalty calculation unit 45, and the consumer loss calculation result 113.

$$\begin{matrix}[ Formula 9 ] & \\ TotalLoss = {w}_{1} \times {\sum }_{a} \{ {incomeLoss\_trans}_{a} + {penalty}_{a} \} + {w}_{2} \times {\sum }_{a} c o n s u m e r L o s {s}_{a} & ( 9 )\end{matrix}$$

Here, TotalLoss is a total loss, incomeLoss_transₐ is the consignment income decrease amount of the area a, penaltyₐ is the power outage penalty of the area a, consumerLossₐ is a consumer loss of the area a, and w₁ and w₂ may be freely set weight coefficients.

The total cost calculation unit 37 can calculate a total cost by the following formula based on a power supply operating cost calculation result and a power supply vehicle operating cost calculation result.

$$\begin{matrix}[ Formula 10 ] & \\ TotalCost = {\sum }_{g} {cost\_gene}_{g} + {\sum }_{g} {cost\_reconst}_{g} + {\sum }_{v} cost\_p {\_vehicle}_{v} & ( 10 )\end{matrix}$$

Here, TotalCost is a total cost, cost_gene_{g} is an operating cost (yen) of a power supply a, and cost_reconst_{g} is a power supply shift cost (yen) of the power supply a. Note that although cost_reconst_{g} is an operating cost that occurs when a power plant is allocated to an area different from that in a normal time, cost_reconst_{g} may be set to 0 in the case of an initial plan.

Based on the calculated total loss and total cost, the total benefit evaluation unit 38 can calculate an overall evaluation value, that is, an overall evaluation value of the initial contingency plan by the following formula (step S305).

$$\begin{matrix}[ Formula 11 ] & \\ TotalBenefit = - TotalLoss - TotalCost & ( 11 )\end{matrix}$$

Here, TotalBenefit is a total benefit.

The above-described result may be stored in the initial contingency plan evaluation result 116 (step S305), and the processing may be ended.

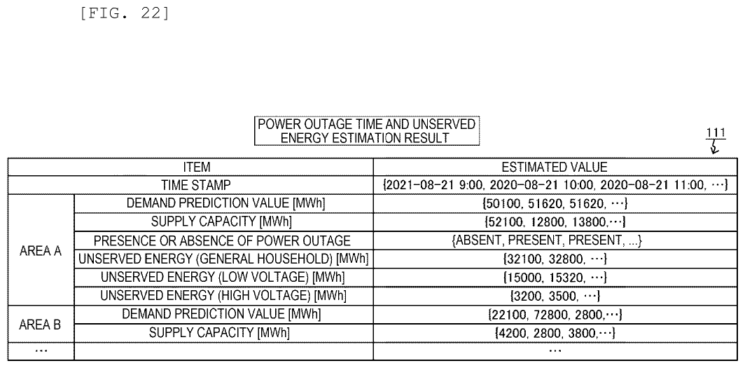

FIG. 20 is an example of the initial contingency plan evaluation result 116 in which a “supply source power plant ID” indicating a supply source power plant, an “allocated power supply vehicle ID” indicating an allocated power supply vehicle, an “allocated storage battery ID” indicating information on an allocated storage battery, and a calculation result of values in the cost benefit evaluation may be stored for each area, the “supply source power plant ID”, the “allocated power supply vehicle ID” and the “allocated storage battery ID” forming the contingency plan.

After the cost benefit evaluation of the initial contingency plan (step S204) is ended, the cost benefit evaluation unit 34 may end the countermeasure-not-taking cost benefit evaluation processing.

When the countermeasure-not-taking cost benefit evaluation processing (step S100) ends, the disaster countermeasure plan making system 10 may perform processing of provisional contingency plan assumption (step S101).

FIG. 8 is a flowchart illustrating a processing procedure of the provisional contingency plan assumption of S101. The contingency plan assumption unit 31 can assume a provisional contingency plan by each of the power supply allocation assumption unit 40, the power supply vehicle dispatch area assumption unit 41, and the storage battery operating area assumption unit 42 assuming asset allocation in each area.

In the assumption of the provisional contingency plan, first, the power supply allocation assumption unit 40 may assume allocation of an area where a corresponding power plant performs power supply (step S400). Specifically, a single or a plurality of supply destination areas different from a supply destination area in normal time in the power supply list 100 can be allocated as a supply destination of each power plant at random. Here, the “random allocation” means appropriate allocation of a user of the power transmission and distribution operator. Next, the power supply vehicle dispatch area assumption unit 41 assumes, based on the power supply vehicle information 106, allocation of an area where a corresponding power supply vehicle performs power supply (step S401). In the assumption of the power supply vehicle dispatch area, for example, a single or a plurality of supply destination areas different from an initial dispatch area in the power supply vehicle information 106 can be allocated as a supply destination of each power supply vehicle at random. Here, the “random allocation” means appropriate allocation of a user of the power transmission and distribution operator. Next, the storage battery operating area assumption unit 42 assumes operation and non-operation of each storage battery based on the area-specific storage battery information 107 (step S402). In the assumption of the storage battery operation and non-operation, for example, the operation or non-operation can be set at random for each storage battery in the area-specific storage battery information 107.

With the above processing, the power plant, the power supply vehicle, and the storage battery to be allocated to each area are assumed as a provisional contingency plan, and the processing of the provisional contingency plan assumption may be ended.

Next, the power outage time and unserved energy estimation unit 32 can perform processing of estimating presence or absence of a power outage and unserved energy in each area for each future time period in which a set power supply plan is to be carried out, by using the assumed contingency plan, the area demand prediction value 101, the renewable energy power generation amount prediction value, and the facility failure prediction result (step S102).

An electric power supply amount of each area is calculated based on the assumed contingency plan, the renewable energy power generation amount prediction value, and the facility failure prediction result for the area, and the presence or absence of a power outage and the unserved energy for each time period can be estimated by comparing the calculated electric power supply amount with the area demand prediction value.

For example, operation availability of an allocated power plant is determined based on information on the power plant allocated to the area in the assumed contingency plan and the facility failure prediction result, and if the power plant can operate, “maximum output in the power supply list 100 in FIG. 13×time” can be calculated as the electric energy that the power plant can supply to the area in the time period.

Further, based on information on the allocated power supply vehicle in the assumed contingency plan, “maximum output in the power supply vehicle information 106 in FIG. 14×time” can be calculated as the electric energy that the power supply vehicle can supply in the time period. At this time, supply availability may be determined based on how long the time period, in which set power supply is to be performed, occupies an elapsed time from a power supply start time. For example, when an elapsed time from the power supply start time is T, a total electric power supply amount up to the time period is calculated using “maximum output of the power supply vehicle×T”, and the value is compared with the supply allowing capacity in the power supply vehicle information 106. When the “total electric power supply amount up to the time period≥the supply allowing capacity”, it can be determined that electric power supply is impossible, and when “the total electric power supply amount up to the time period<the supply allowing capacity”, it can be determined that the electric power supply is possible. The symbol T is used in the scope of the present formula.

Further, information on the allocated storage battery in the assumed contingency plan and “maximum output in the area-specific power storage battery information 107 in FIG. 15×time” can be calculated as the electric energy that the storage battery can supply in the time period. At this time, supply availability may be determined based on how long the time period, in which set power supply is to be performed, occupies an elapsed time from a power supply start time. For example, when an elapsed time from the power supply start time is T, a total electric power supply amount up to the time period is calculated using “maximum output T of the storage battery×T”, and the value is compared with a capacity in the area-specific storage battery information 107. When the “total electric power supply amount up to the time period≥the capacity”, it can be determined that the electric power supply is impossible, and when the “total electric power supply amount up to the time period<the capacity”, it can be determined that the electric power supply is possible. The symbol T may be used in the scope of the present formula.

The electric power supply amount in each time period of the area can be calculated by adding up a total value of the electric power supply amounts of the power generator, the power supply vehicle, and the storage battery in each time period calculated in this manner and the renewable energy power generation amount prediction value in each time period. FIG. 16 is an example of the area demand prediction value 101 in which the demand prediction value for each consumer type (general household, business operator (high voltage), business operator (low voltage)) and the total amount demanded are stored for each time period of each area. The electric power supply amount in each time period of the area is compared with the total amount demanded of the area in the area demand prediction value 101. When “the electric power supply amount≥the total amount demanded”, it can be determined that a power outage is absent, and when “the electric power supply amount<the total amount demanded”, it can be determined that a power outage is present. When a power outage is present, the total amount demanded can be estimated as the unserved energy in the time period. The unserved energy for each consumer type can be estimated by referring to the demand prediction value for each consumer type (general household, business operator (high voltage), business operator (low voltage)) in the area demand prediction value 101. The estimation result of the presence or absence of a power outage and the unserved energy of each area estimated in this way can be stored in the power outage time and unserved energy estimation result 111 in the format illustrated in FIG. 22.

Next, the cost benefit evaluation unit 34 can evaluate the cost and benefit to be generated, based on the assumed provisional contingency plan and the unserved energy estimation result (step S103).

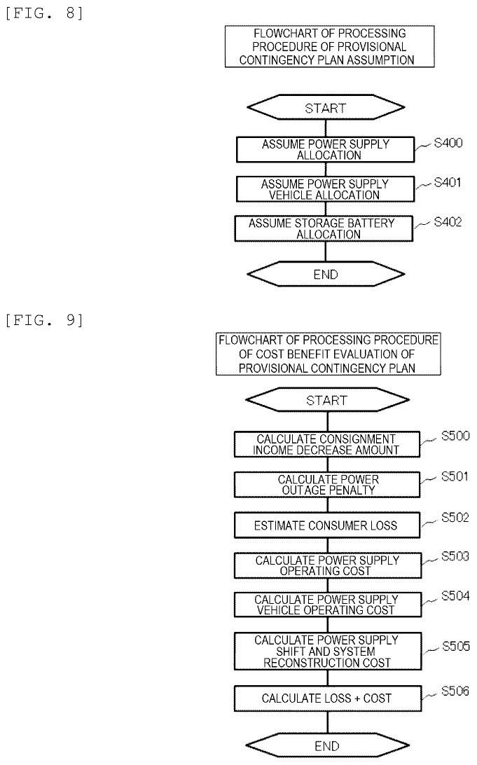

FIG. 9 is a flowchart illustrating details of a processing procedure (step S103) of the cost benefit evaluation of the provisional contingency plan.

When the cost benefit evaluation of the provisional contingency plan is started, first, the consignment income decrease amount calculation unit 44 can perform processing of calculating a consignment income decrease amount based on the estimation result of the unserved energy of each area (step S500). Specifically, a consignment rate unit price (yen/kwh) for each consumer type (general household, business operator (high voltage), business operator (low voltage)) is set first. Next, as shown in formula (2), by taking the product of unserved energy for each consumer type in the power outage time and unserved energy estimation result 111, it is possible to calculate the consignment income decrease amount of each consumer type.

By adding up the consignment income decrease amounts of the respective consumer types, it is possible to calculate a consignment income decrease amount of all consumers.

Next, the power outage penalty calculation unit 45 can perform processing of calculating a loss due to a penalty of the power outage based on the estimation result of the unserved energy of each area (step S501). Specifically, first, values of a penalty unit price (yen/kWh) and allowable unserved energy (MWh) can be set to any value. The any value may be any value appropriately selected by a power company itself. Next, as shown in formula (6), a power outage penalty can be calculated by multiplying a deviation amount from allowable unserved energy of the total unserved energy in all target time periods by the penalty unit price.

Next, the consumer loss calculation unit 35 can perform processing of calculating damages to the consumer based on the estimation result of the unserved energy of each area (step S502). Details of the consumer loss calculation processing will be described later in section 3-2 “various types of processing of consumer loss calculation”.

Next, the power supply operating cost calculation unit 46 can calculate an operating cost of each power supply, by using the power supply allocation of the assumed contingency plan, the power supply list 100, and the area demand prediction value 101 (step S503). Specifically, first, it is possible to extract a power plant to operate that is allocated to an area and determined in step S201. When one power generator is allocated to one area, a total amount demanded indicated by the area demand prediction value of the area can be set to a power generation amount of the power plant in all time periods. When a plurality of power generators are allocated to one area, the power generation amount of each power plant can be calculated by proportionally dividing the total amount demanded by a ratio of maximum outputs of the allocated power plants with reference to the power supply list 100. Next, with reference to the power supply list 100, the cost function coefficient a_{g}, the cost function coefficient b_{g}, and the cost function coefficient c_{g} of the allocated power plant are extracted. By using the coefficients (a_{g}, b_{g}, c_{g}) of the power generator cost function, the cost required for the operation in each time period can be calculated by formula (7).

Next, the power supply vehicle operating cost calculation unit 48 calculates a cost for the power supply vehicle dispatch and operation by using the allocation of the power supply vehicle dispatch of the contingency plan assumed in step S401 and the power supply vehicle operation unit price 114 (step S504). Specifically, first, a power supply vehicle allocated to an area can be extracted. Next, a cost function coefficient aᵥₑₕ, a cost function coefficient bᵥₑₕ, and a cost function coefficient C_{Veh} of the allocated power supply vehicle can be extracted with reference to the power supply vehicle operation unit price 114 in FIG. 19. Next, by using the cost function coefficients (aᵥₑₕ, bᵥₑₕ, cᵥₑₕ), it is possible to calculate the cost for the operation in each time period by formula (8).

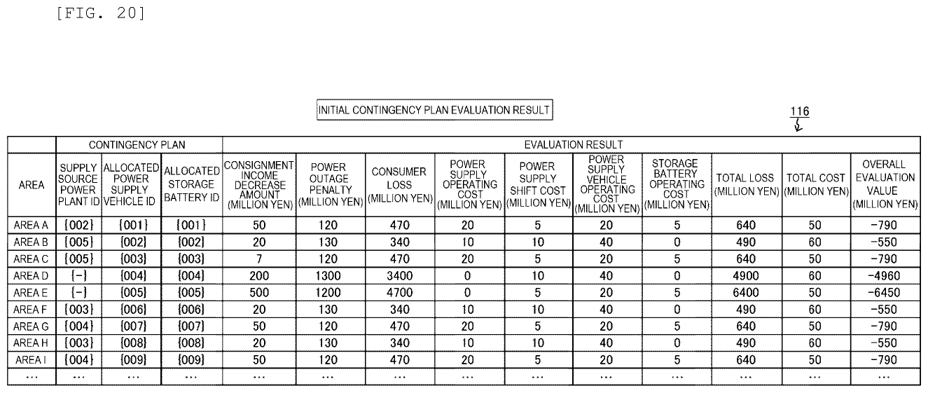

Next, the power supply shift and system reconstruction cost calculation unit 47 can calculate a cost for power supply shift and system reconstruction (step S505). Specifically, first, a power plant assigned to an area can be extracted. Next, with reference to the power supply shift cost unit price 110 in FIG. 18, it is possible to extract an operating cost for changing a supply area. When the power supply allocation of the assumed contingency plan is different from a supply destination area in normal time, it can be determined that an operating cost for changing the supply area is additionally generated for the power generator.

Next, the total loss calculation unit 36 can calculate a total loss by formula (9) based on a consignment income decrease amount calculation result, a power outage penalty calculation result, and a consumer loss calculation result.

The total cost calculation unit 37 can calculate a total cost by formula (10) based on a power supply operating cost calculation result, a power supply vehicle operating cost calculation result, and a power supply shift cost calculation result obtained from the processing by the power supply shift and system reconstruction cost calculation unit 47.

Based on the total loss calculated by the total loss calculation unit 36 and the total cost calculated by the total cost calculation unit 37, the total benefit evaluation unit 38 can calculate an overall evaluation value, that is, an overall evaluation value of the provisional contingency plan by formula (11) (step S506).

Thereafter, the cost benefit evaluation processing (S103) of the provisional contingency plan can be ended.

When the cost benefit evaluation processing (S103) of the provisional contingency plan ends, the disaster countermeasure plan making system 10 can perform processing of improvement degree calculation (step S104).

Specifically, in the improvement degree calculation, an improvement degree of the overall evaluation value can be calculated by calculating a difference between the overall evaluation value (total benefit) of the provisional contingency plan calculated in S103 and the overall evaluation value (total benefit) of the initial contingency plan calculated in S305.

By repeating steps S101 to S104 until the specified end condition is satisfied, it is possible to search for a contingency plan having a high overall evaluation value (step S105). The search may be performed via the benefit improvement unit 33. The search may be performed, for example, by using a metaheuristic method such as a greedy algorithm or a genetic algorithm to set the improvement degree as an evaluation function, and generating a new provisional contingency plan so as to improve the evaluation function, thereby increasing the improvement degree. In this manner, the disaster countermeasure plan making unit 30 can evaluate a plurality of countermeasures based on set conditions, generate a countermeasure having a high evaluation value of benefit from the plurality of countermeasures, and output the countermeasure. The output can be performed by the output unit 24, and the output can also be performed by displaying on the use terminal 12 of the power transmission and distribution operator through the communication unit 25 via the communication network 11. The disaster countermeasure plan making system evaluates a plurality of countermeasures.

With the configuration, optimization processing is performed, and an optimal plan can be obtained under given conditions.

At this time, only the contingency plan for which a ratio of α and β is a in predetermined range, for example, “any minimum value<α/β<any maximum value” can be employed, a being a countermeasure cost of the power transmission and distribution operator that is a total value of the calculated power supply operating cost, the power supply vehicle operating cost, and the power supply shift cost and β being a consumer loss calculated at an early stage. Here, the any minimum value and the any maximum value may be any value determined by the power transmission and distribution operator as appropriate, and it goes without saying that the any minimum value and the any maximum value are determined so that “any minimum value<any maximum value”. Further, with respect to an evaluation value of a contingency plan that deviates from a predetermined range, a penalty corresponding to the deviation may be given.

As described, the plan making unit may generate and/or output a countermeasure by which a ratio of the cost required for the countermeasure of the power transmission and distribution operator and the power outage loss of the power consumer falls within a specified range.

As described above, by setting the ratio of α and β within a predetermined range, there is an advantage of ensuring fairness of the cost sharing between the power consumer and the power transmission and distribution operator. With the processing, it can be expected that the balance between the expense of the consumer and the expense of the power transmission and distribution operator which are caused by a disaster is maintained in a predetermined range, and that a case in which the power transmission and distribution operator performs an excessive worth of countermeasure than the consumer loss is prevented.

In addition, only the contingency plan by which 0, which is a difference between the consumer loss of the initial contingency plan and the consumer loss of the provisional contingency plan, is equal to or greater than a freely determined threshold may be adopted, or with respect to an evaluation value of a contingency plan by which 0 is equal to or less than the threshold, a penalty corresponding to the deviation may be given. With such processing, making of a plan based on the minimum loss compensation for the consumer can be expected. The freely determined threshold may be a threshold freely determined by the power transmission and distribution operator as appropriate.

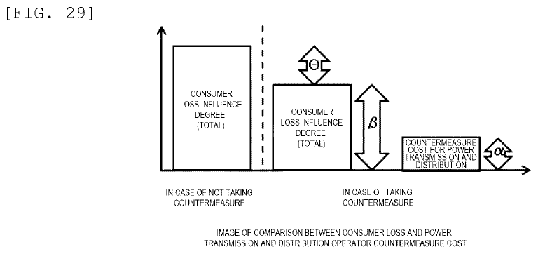

FIG. 29 illustrates a comparison image of the consumer loss and the countermeasure cost of the power transmission and distribution operator. In the drawing, the countermeasure cost a of the power transmission and distribution operator is expressed as a “power transmission and distribution countermeasure cost” and the consumer loss β is expressed as a “consumer loss influence degree (total)”. The “power transmission and distribution countermeasure cost” and the “consumer loss influence degree (total)” presented in the case of taking a countermeasure are the provisional contingency plan. The “consumer loss influence degree (total)” presented in the case of not taking a countermeasure is the initial contingency plan. The difference between the consumer loss of the initial contingency plan and the consumer loss of the provisional contingency plan is denoted by 0.

When the specified end condition is satisfied in step S105, it is possible to adopt a contingency plan having the highest improvement degree in the search process as the best plan (step S106). The result can be stored in the contingency plan optimization result 112, and the processing can be ended.

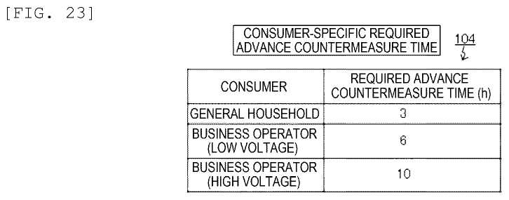

FIG. 21 is an example of the contingency plan optimization result 112 in which information on the supply source power plant, the allocated power supply vehicle, the allocated storage battery which are a contingency plan, and a calculation result of values in the cost benefit evaluation may be stored for each area.

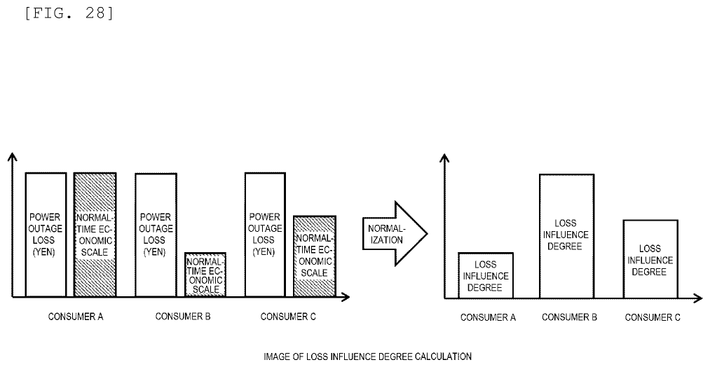

For example, as a specific method of notifying the power transmission and distribution operator of the above-described optimization result, a screen illustrated in FIG. 27 can be displayed on the use terminal of the power transmission and distribution operator. As a display method, for example, an unserved energy prediction value of each area at a designated date and time, an estimated operation and stop status of each power plant, and a supply destination in a contingency plan may be visually illustrated. The total benefit of the contingency plan, a benefit improvement amount compared with the initial contingency plan, and the consumer loss may be displayed together with the breakdown.

### (3-2) Various Types of Processing of Consumer Loss Calculation

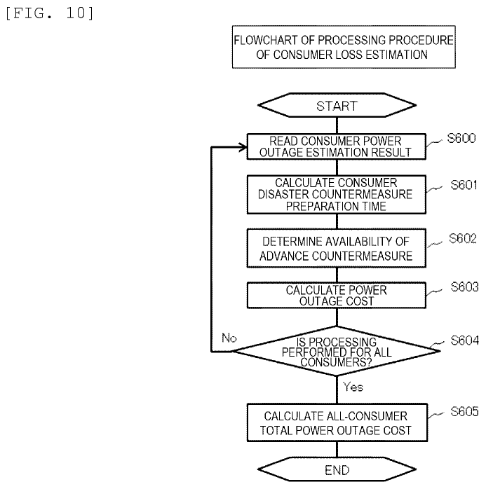

FIG. 10 is a flowchart illustrating a processing procedure of consumer loss calculation by the disaster countermeasure plan making system 10. The consumer loss calculation unit 35 of the disaster countermeasure plan making system 10 can execute sequentially consumer power outage estimation result reading processing (step S600), consumer disaster countermeasure preparation time calculation processing (step S601), advance countermeasure availability determination processing (step S602), power outage cost calculation processing (step S603), condition branch processing (step S604) related to “Is processing performed for all consumers?”, and all-consumer total power outage cost calculation processing (step S605).

When the consumer loss calculation processing is started, first, the consumer disaster countermeasure preparation time calculation unit 50 illustrated in FIG. 4 reads data of the power outage time and unserved energy estimation result 111 (step S600).

Next, using the read data, the consumer disaster countermeasure preparation time calculation unit 50 can calculate a preparation time of a disaster countermeasure for each consumer type (step S601). Specifically, it is possible to extract a time point at which a power outage occurs first, that is, a power outage occurrence start time-point by referring to information indicating presence or absence of a power outage occurrence in the power outage time and unserved energy estimation result 111. The preparation time of the disaster countermeasure can be calculated by taking a difference between the power outage occurrence start time-point and a current time-point.

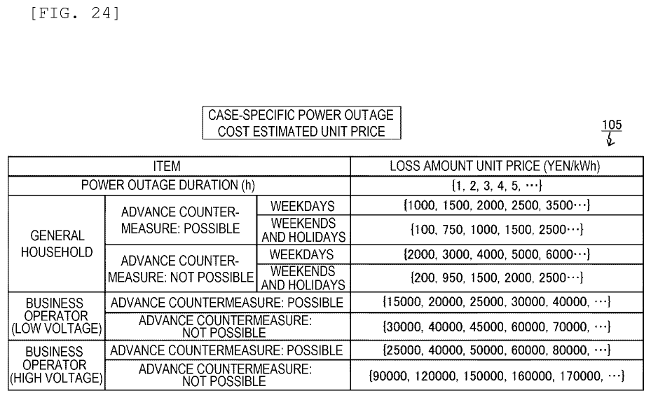

Next, the advance countermeasure availability determination unit 51 determines availability of an advance countermeasure for each consumer by using the disaster countermeasure preparation time of each consumer calculated by the consumer disaster countermeasure preparation time calculation unit 50 and the consumer-specific required advance countermeasure time 104 (step S602). FIG. 23 is an example of the consumer-specific required advance countermeasure time 104 in which a required advance countermeasure time of each consumer is set for each consumer type. Specifically, when “the disaster countermeasure preparation time of the consumer≥the required advance countermeasure time of the consumer”, it can be determined that it is possible for the consumer of the consumer type to take an advance countermeasure, and when the “disaster countermeasure preparation time of the consumer<the required advance countermeasure time of the consumer”, it can be determined that it is not possible for the consumer of the consumer type to take an advance countermeasure.

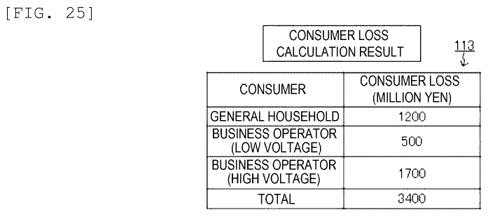

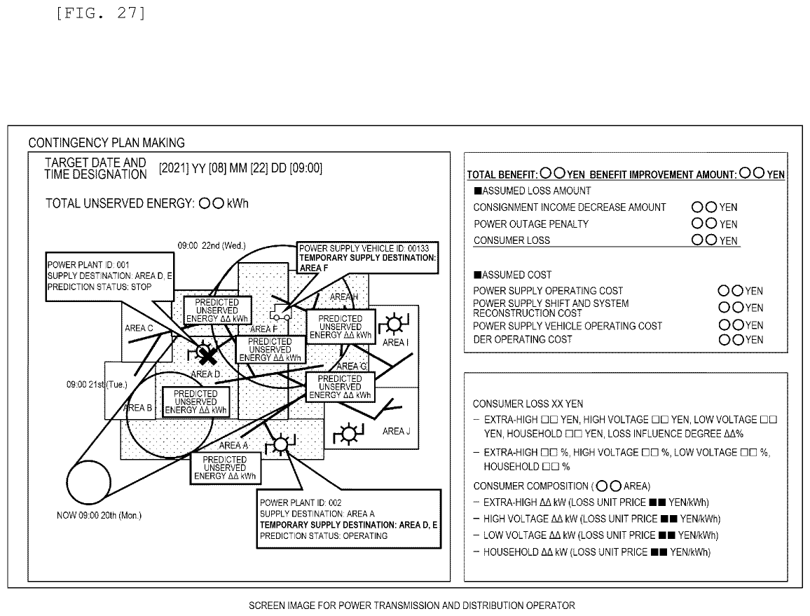

Next, the power outage cost calculation unit 52 can calculate a cost of the consumer incurred due to the power outage, that is, the power outage cost, by using the unserved energy in each time period of the consumer obtained from the power outage time and unserved energy estimation result 111 described above, the advance countermeasure availability determination result determined by the advance countermeasure availability determination unit 51, and the case-specific power outage cost estimated unit price 105 (step S603). FIG. 24 is an example of the case-specific power outage cost estimated unit price 105 in which a loss amount unit price corresponding to the power outage duration may be set for each consumer type and each of “possible” and “not possible” of the advance countermeasure. In addition to the advance countermeasure availability, a loss amount unit price corresponding to a date type such as weekdays, weekends, holidays, and the like may be set. FIG. 26 illustrates an image of a change according to duration of the case-specific power outage cost estimated unit price.

As described above, the power outage loss of the power consumer, that is, a loss including the power outage cost received by the power consumer due to the power outage may be calculated based on the unserved energy and the above-described first information, that is, information including the time that the power consumer to be affected by the power outage in the area for which the power outage is predicted requires to take a countermeasure in advance. With such a configuration, it is possible to accurately evaluate the power outage loss of the consumer, and it is possible to more accurately ensure the fairness between the power transmission and distribution operator and the consumer, and to make a better disaster countermeasure plan.

The time required for the advance countermeasure described above may depend on the type of the power consumer, and may be different for each type of the power consumer. The first information may include the type of the power consumer. With such a configuration, it is possible to make a disaster countermeasure plan with higher accuracy in consideration of the type of the consumer.

Further, the above-described first information may include information on a loss amount per unit time depending on the type of the power consumer, and may include information on the loss amount per unit time different for each type of power consumer. With such a configuration, it is possible to make a disaster countermeasure plan with higher accuracy in consideration of the loss amount related to the advance countermeasure based on the type of the consumer.

As a specific method of calculating the power outage cost, first, an elapsed time from the power outage occurrence start time-point extracted as described above up to each time period is set as the power outage duration of the time period. Then, by obtaining the product of the power outage cost estimated unit price corresponding to the time (date type), the power outage duration, the advance countermeasure availability in each time period for each consumer type, and the unserved energy of the consumer type in the time period, the loss amount for each consumer type is calculated, and by adding up all the consumer types, the cost of all the consumers incurred due to the power outage can be calculated.

At this time, for example, a normal-time economic scale for each consumer type may be set to any value equal to or greater than 0, and the loss amount of each consumer type may be divided by this value to calculate the degree of influence that the loss have on normal-time economic activities, and the calculated degree of influence may indicate the loss of the consumer. The economic scale may be an economic scale of a small store or a general household with respect to a factory. Here, the size may be represented by a numerical value. With the processing, for example, evaluation of the loss based on a difference in economic scale depending on the type of the consumer can be expected. An image of the evaluation of the loss based on the difference in economic scale is illustrated in FIG. 28. In the graph shown in FIG. 28, a left graph is an image showing the amount of power outage losses and the normal-time economic scales for consumers A, B, and C, and a vertical axis thereof may be a loss amount and may represent the normal-time economic scale. The left graph in FIG. 28 is obtained by normalizing values, which are obtained by dividing the loss amounts of the consumers A, B, and C by the respective normal-time economic scales, as loss influence degrees. In the case of FIG. 28, for example, it can be grasped that the loss influence degree of the consumer A is relatively smaller, and the loss influence degree of the consumer C is relatively larger. As described, there is an advantage that the influence of the loss corresponding to the consumer can be estimated.

An example of a method of calculating the cost of the consumer is indicated by formula (12).

$$\begin{matrix}[ Formula 12 ] & \\ c o n s u m e r L o s {s}_{a} = {\sum }_{c} \frac{{\sum }_{t 1} P L o s {s}_{a , c , t 1} \times unitLoss ( c , s , t 2 , p r )}{E {C}_{c}} & ( 12 )\end{matrix}$$

Here, consumerLossₐ is a cost of a consumer in the area a, PlosS_{a,c,t1} is total unserved energy (MWh) in a time period t1 of a consumer type c in the area a, unitLoss (c, s, t2, pr) is a power outage cost unit price (yen/kWh) that depends on the consumer type c, a time s, power outage duration t2, and advance countermeasure availability pr, and EC_{c} may be a normal-time economic scale of the consumer type c. Symbols t1 and t2 may be used in the scope of the present formula.

As described above, the plan making unit may calculate the power outage loss of the power consumer based on the normal-time economic scale of the power consumer.

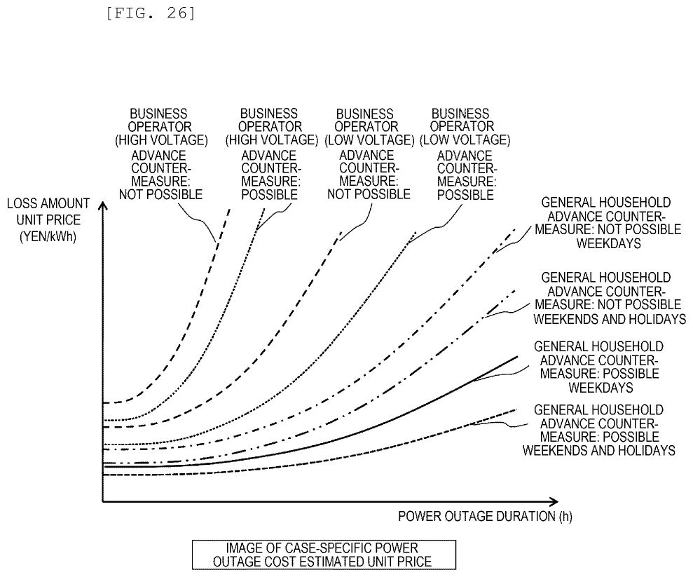

Next, the above-described steps S600 to S604 are repeated until processing is performed for all the consumer types (step S604), and when the processing is performed for all the consumers, the all-consumer total power outage cost calculation unit 53 can sum up the losses of the consumers incurred due to the power outage, calculate the total power outage cost of all the consumers, store the processing result in the consumer loss calculation result 113, and end the processing (step S605). An example of the consumer loss calculation result 113 is shown in FIG. 25.

The electric power transmission and distribution operator may directly control the power plant, the power supply vehicle, and the storage battery based on the contingency plan determined in this manner, or may indirectly implement the contingency plan by transmitting control information to another business operator, for example, a power generation business operator or an external operation business operator of a power supply vehicle and a storage battery.

Although an example in which the power supply vehicle and the storage battery are used as a distributed power supply is described in the embodiment, it goes without saying that a contingency plan can also be made using the same method when another distributed power supply such as an electric vehicle or an emergency power generator is used.

### (4) Effects of Embodiment

As described above, in the disaster countermeasure plan making system according to the embodiment, based on a prediction value of a power outage time and unserved energy of each area at the time of occurrence of a disaster, a prediction value of a power outage time and unserved energy in a case of carrying out a contingency plan corresponding to power supply shift, system switching, and distributed power supply, a type of a consumer in each area, and an advance countermeasure possible time of the consumer, a sales loss of a power transmission and distribution operator such as a consignment income decrease and a power outage penalty, a countermeasure cost such as power generator shift and distributed power supply operating cost, and an economic loss of the consumer incurred due to a power outage can be accurately evaluated, a total benefit of a contingency plan based on the economic loss can be evaluated, a contingency plan improving the total benefit can be made, and the cost effectiveness of the power transmission and distribution operator can be improved.

With such a configuration, it is possible to provide a disaster countermeasure plan making system and a disaster countermeasure plan making method capable of accurately evaluating an economic loss of a consumer incurred due to a power outage, shortening a recovery time from the power outage, and improving the cost effectiveness of a countermeasure of a power transmission and distribution operator. Since a plan for automatically calculating the effect of a countermeasure as an evaluation value by a computer and further improving the evaluation value can be made automatically by a computer, it is possible to shorten a calculation time required for countermeasure planning when a disaster occurs.

The invention is not limited to the embodiment described above, and the components can be modified and embodied in the implementation phase without departing from the gist thereof.

The invention is not limited to the above-described embodiments, and includes various modifications and equivalent configurations within the scope of the appended claims. For example, the above-described embodiment is described in detail for easy understanding of the invention, and the invention is not necessarily limited to those including all the configurations described above. A part of a configuration of one embodiment can be replaced with a configuration of another embodiment. A configuration of one embodiment can also be added to a configuration of another embodiment. Another configuration may be added to a part of the configuration of an embodiment, and a part of the configuration of each embodiment may be deleted or replaced with another configuration.

A part of all of the above-described configurations, functions, processing units, processing methods, and the like may be implemented by hardware by, for example, designing with an integrated circuit, or may be implemented by software by, for example, a processor interpreting and executing a program for implementing each function.

Information such as a program, a table, and a file for implementing each function can be stored in a recording device such as a memory, a hard disk, and a solid state drive (SSD), or in a recording medium such as an IC card, an SD card, and a DVD.

Control lines and information lines considered to be necessary for description are shown, and not all control lines and information lines necessary for implementation are shown. Actually, it may be considered that almost all the configurations are connected to one another.

### REFERENCE SIGNS LIST

10: DISASTER COUNTERMEASURE PLAN MAKING SYSTEM
11: COMMUNICATION NETWORK
12: USE TERMINAL
21: ARITHMETIC UNIT
22: MEMORY
23: INPUT UNIT
24: OUTPUT UNIT
25: COMMUNICATION UNIT
26: STORAGE DEVICE
30: DISASTER COUNTERMEASURE PLAN MAKING UNIT
31: CONTINGENCY PLAN ASSUMPTION UNIT
32: POWER OUTAGE TIME AND UNSERVED ENERGY ESTIMATION UNIT
33: BENEFIT IMPROVEMENT UNIT
34: COST BENEFIT EVALUATION UNIT
35: CONSUMER LOSS CALCULATION UNIT
36: TOTAL LOSS CALCULATION UNIT
37: TOTAL COST CALCULATION UNIT
38: TOTAL BENEFIT EVALUATION UNIT
39: FACILITY FAILURE PREDICTION UNIT
40: POWER SUPPLY ALLOCATION ASSUMPTION UNIT
41: POWER SUPPLY VEHICLE DISPATCH AREA ASSUMPTION UNIT
42: STORAGE BATTERY OPERATING AREA ASSUMPTION UNIT
43: RENEWABLE ENERGY POWER GENERATION AMOUNT PREDICTION UNIT
44: CONSIGNMENT INCOME DECREASE AMOUNT CALCULATION UNIT
45: POWER OUTAGE PENALTY CALCULATION UNIT
46: POWER SUPPLY OPERATING COST CALCULATION UNIT
47: POWER SUPPLY SHIFT AND SYSTEM RECONSTRUCTION COST CALCULATION UNIT
48: POWER SUPPLY VEHICLE OPERATING COST CALCULATION UNIT
50: CONSUMER DISASTER COUNTERMEASURE PREPARATION TIME CALCULATION UNIT
51: ADVANCE COUNTERMEASURE AVAILABILITY DETERMINATION UNIT
52: POWER OUTAGE COST CALCULATION UNIT
53: ALL-CONSUMER TOTAL POWER OUTAGE COST CALCULATION UNIT

1. A disaster countermeasure plan making system, comprising:
an arithmetic unit configured to execute arithmetic processing; and
a storage unit accessible by the arithmetic unit, wherein
the arithmetic unit includes a plan making unit that makes a countermeasure plan in preparation for a predetermined disaster, and
the plan making unit
generates a first prediction value for each of a power outage time and unserved energy in an area for which a power outage is predicted due to the disaster,
generates a second prediction value for each of a power outage time and unserved energy in a case where a countermeasure is taken in the area, and
evaluates at least a benefit of the countermeasure based on the first prediction value, the second prediction value, first information including a time that is required for a power consumer to be affected by the power outage in the area to take the countermeasure in advance, and second information regarding a loss associated with the disaster.

2. The disaster countermeasure plan making system according to claim 1, wherein
the second information is information including a sales loss of a power transmission and distribution operator, a cost required for the countermeasure, and a power outage loss of the power consumer.

3. The disaster countermeasure plan making system according to claim 2, wherein
the sales loss of the power transmission and distribution operator includes a consignment income decrease amount or a power outage penalty amount, and
the cost includes a cost required for power supply operating or a distributed power supply operating cost.

4. The disaster countermeasure plan making system according to claim 2, wherein
the power outage loss of the power consumer is calculated based on the unserved energy and the first information.

5. The disaster countermeasure plan making system according to claim 2, where
the first information includes a type of the power consumer, and
the time required for taking the countermeasure in advance depends on the type of the power consumer.

6. The disaster countermeasure plan making system according to claim 4, wherein
the first information includes information on a loss amount per unit time depending on a type of the power consumer.

7. The disaster countermeasure plan making system according to claim 1, wherein
the plan making unit evaluates a plurality of countermeasures based on a set condition, and generates a countermeasure having a high evaluation value of benefit from the plurality of countermeasures.

8. The disaster countermeasure plan making system according to claim 1, wherein
the plan making unit calculates a power outage loss of the power consumer based on a normal-time business size of the power consumer.

9. The disaster countermeasure plan making system according to claim 1, wherein
the plan making unit generates a countermeasure by which a ratio of a cost required for a countermeasure of a power transmission and distribution operator and a power outage loss of the power consumer falls within a specified range.

10. A disaster countermeasure plan making method for making a countermeasure plan in preparation for a predetermined disaster and to be executed by a disaster countermeasure plan making system,
the disaster countermeasure plan making system including
an arithmetic unit configured to execute arithmetic processing, and
a storage device accessible by the arithmetic unit,
the method comprising:
causing the arithmetic device to generate a first prediction value for each of a power outage time and unserved energy in an area for which a power outage is predicted due to the disaster;
causing the arithmetic device to generate a second prediction value for each of a power outage time and unserved energy in a case where a countermeasure is taken in the area; and
causing the arithmetic device to evaluate at least a benefit of the countermeasure based on the first prediction value, the second prediction value, first information including a time that is required for a power consumer to be affected by the power outage in the area to take the countermeasure in advance, and second information regarding a loss associated with the disaster.
